(19) United States
(12) Patent Application Publication
(10) Pub. No.: US 2025/0292542 A1
(43) Pub. Date: Sep. 18, 2025

(54) WORKLOAD CLASSIFICATION USING A LARGE LANGUAGE MODEL AND GRAMIAN ANGULAR FIELD IMAGES

(71) Applicant: Dell Products L.P., Round Rock, TX (US)

(72) Inventors: Ravi Shukla, Bengaluru (IN); Saheli Saha, Kolkata (IN); Ramakanth Kanagovi, Hyderabad (IN)

(21) Appl. No.: 18/606,216

(22) Filed: Mar. 15, 2024

(51) Int. Cl. G06V 10/764

(52) U.S. Cl. CPC G06V 10/764

(57) ABSTRACT

A method for workload classification. The method includes: obtaining a workload log for a workload; producing, for the workload and based on the workload log, a workload gramian angular field (GAF) image set; and assigning, to the workload, a workload class at least based on the workload GAF image set. More specifically, embodiments described herein integrate visual representations of workload logs (in the form of GAF images) and advanced language understanding capabilities (offered by a large language model) to classify workload logs, and thus workloads, as anomalous or non-anomalous.

### BACKGROUND

With the increased migration of workloads (e.g., services, computational tasks/functions, data transactions, software applications, etc.) to cloud computing infrastructure, the challenge lies with the efficient detection of anomalies therein in order to address technical issues promptly.

### SUMMARY

In general, in one aspect, embodiments described herein relate to a method for workload classification. The method includes: obtaining a workload log for a workload; producing, for the workload and based on the workload log, a workload gramian angular field (GAF) image set; and assigning, to the workload, a workload class at least based on the workload GAF image set.

In general, in one aspect, embodiments described herein relate to a non-transitory computer readable medium (CRM). The non-transitory CRM includes computer readable program code, which when executed by a computer processor, enables the computer processor to perform a method for workload classification. The method includes: obtaining a workload log for a workload; producing, for the workload and based on the workload log, a workload gramian angular field (GAF) image set; and assigning, to the workload, a workload class at least based on the workload GAF image set.

In general, in one aspect, embodiments described herein relate to a system. The system includes: at least one enterprise device; and a workload classifier operatively connected to the at least one enterprise device, and including a computer processor configured to perform a method for workload classification. The method includes: obtaining, from an enterprise device of the at least one enterprise device, a workload log for a workload instantiated thereon; producing, for the workload and based on the workload log, a workload gramian angular field (GAF) image set; and assigning, to the workload, a workload class at least based on the workload GAF image set.

Other aspects of the embodiments described herein will be apparent from the following description and the appended claims.

### BRIEF DESCRIPTION OF DRAWINGS

Certain embodiments described herein will be described with reference to the accompanying drawings. However, the accompanying drawings illustrate only certain aspects or implementations of the embodiments by way of example and are not meant to limit the scope of the claims.

FIG. 1A shows a system in accordance with one or more embodiments described herein.

FIG. 1B shows a workload classifier in accordance with one or more embodiments described herein.

FIG. 2 shows a flowchart describing a method for processing historical workload logs in accordance with one or more embodiments described herein.

FIGS. 3A-3C show a flowchart describing a method for processing new workload logs in accordance with one or more embodiments described herein.

FIG. 4 shows a computing system in accordance with one or more embodiments described herein.

FIG. 5 shows an example generation of a workload gramian angular field image set in accordance with one or more embodiments described herein.

### DETAILED DESCRIPTION

Specific embodiments will now be described with reference to the accompanying figures.

In the below description, numerous details are set forth as examples of embodiments described herein. It will be understood by those skilled in the art (who also have the benefit of this Detailed Description) that one or more embodiments of embodiments described herein may be practiced without these specific details, and that numerous variations or modifications may be possible without departing from the scope of the embodiments described herein. Certain details known to those of ordinary skill in the art may be omitted to avoid obscuring the description.

In the below description of the figures, any component described with regard to a figure, in various embodiments described herein, may be equivalent to one or more like-named components described with regard to any other figure. For brevity, descriptions of these components may not be repeated with regard to each figure. Thus, each and every embodiment of the components of each figure is incorporated by reference and assumed to be optionally present within every other figure having one or more like-named components. Additionally, in accordance with various embodiments described herein, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Throughout this application, elements of figures may be labeled as A to N. As used herein, the aforementioned labeling means that the element may include any number of items and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

In general, embodiments described herein relate to workload classification using a large language model (LLM) and gramian angular field (GAF) images. Particularly, with the increased migration of workloads (e.g., services, computational tasks/functions, data transactions, software applications, etc.) to cloud computing infrastructure, the challenge lies with the efficient detection of anomalies therein in order to address technical issues promptly. Workloads generate events, which are subsequently recorded in respective workload logs. Identifying potential anomalies by way of said workload logs is essential for proactively detecting issues that may impact the performance or reliability of said workloads. The current practice, however, of manually inspecting said workload logs tends to be a tedious and time-consuming task, which is unsuitable for addressing any issues in a systematic and timely manner.

Embodiments described herein, therefore, streamline the analysis of workload logs and enhance the efficiency of technical issue resolution. To this end, embodiments described herein integrate visual representations of workload logs (in the form of GAF images) and advanced language understanding capabilities (offered by a LLM) to classify workload logs, and thus workloads, as anomalous or non-anomalous, and to provide descriptions for any anomalies if detected.

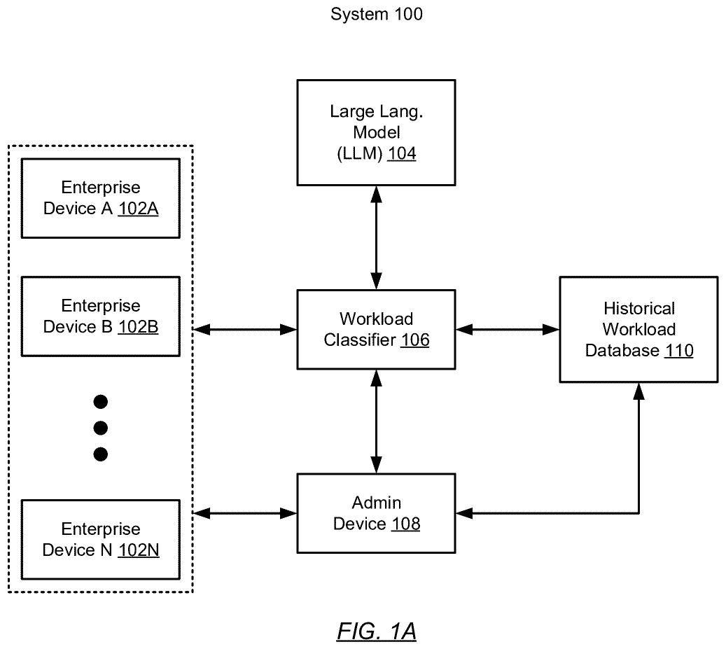

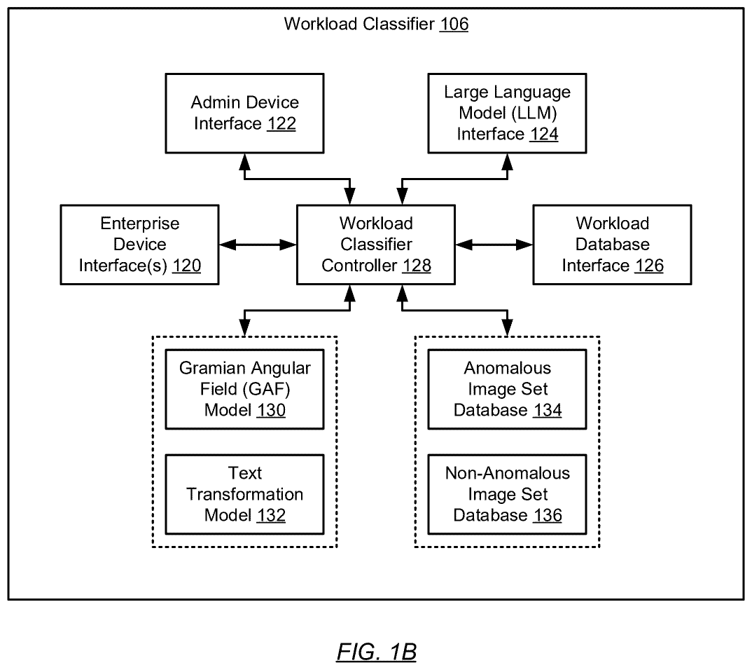

FIG. 1A shows a system in accordance with one or more embodiments described herein. The system (100) may include any number of enterprise devices (102A-102N), a LLM (104), a workload classifier (106), an admin device (108), and a historical workload database (110). Each of these system (100) components is described below.

In one or many embodiment(s) described herein, any enterprise device (102A-102N) may represent any physical or virtual appliance at least configured to receive, generate, process, store, and/or transmit data, as well as provide an environment in which one or many workload(s) may execute thereon. Any said workload (not shown) may refer, but is not limited, to a service offered locally or over a network (not shown), a computational task or function, a data transaction, or a software application. Further, in providing said execution environment for any workload(s) instantiated thereon, any enterprise device (102A-102N) may include or have access to, and thus allocate and de-allocate, various resources (e.g., computer processors, memory, storage, virtualization, network bandwidth, etc.), as needed, to the workload(s). Any enterprise device (102A-102N), moreover, may also include functionality to: record events, as well as information descriptive thereof, pertaining to any workload(s) thereon in the form of workload logs (described below); and maintain or provide a workload description (i.e., text summarizing a purpose for the workload) for any workload(s) thereon. One of ordinary skill, however, will appreciate that any enterprise device (102A-102N) may perform other functionalities without departing from the scope of the embodiments described herein.

In one or many embodiment(s) described herein, any workload log may refer to a structured file including any number of event entries respectively pertaining to any number of events associated with a given workload. An event, in turn, may refer to a notification entailing details corresponding to a significant action or occurrence at least concerning the given workload. Examples of said details, for a given event, may include: an event sequence number assigning a unique identifier to the given event based on a chronological order in which the given event transpired; an event timestamp encoding a date and/or time at which the given event transpired; an event severity (e.g., low, medium, high, etc.) indicating a seriousness or criticality of the given event; an event category (e.g., information, warning, error, etc.) specifying a type of the given event; and an event description (also referred to herein as a workload log message) encompassing a text summary describing the given event. Further, said details, for any given event, are not limited to the aforementioned specific examples.

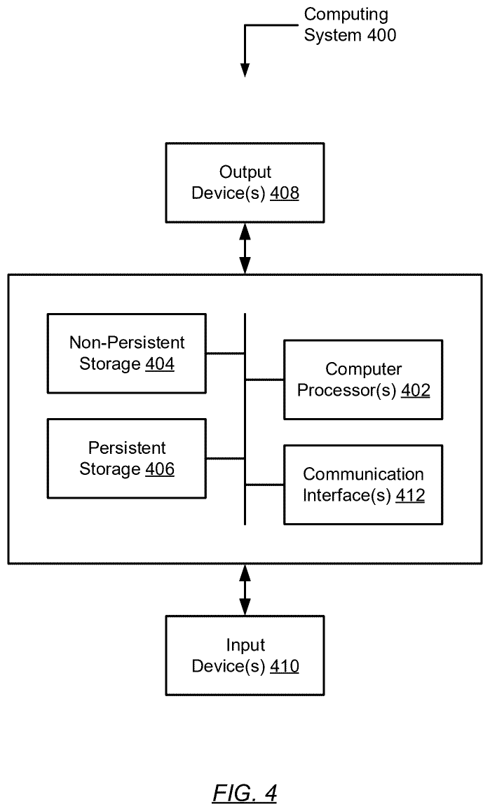

In one or many embodiment(s) described herein, any enterprise device (102A-102N) may be implemented through on-premises infrastructure, cloud computing infrastructure, or any hybrid infrastructure thereof. Any enterprise device (102A-102N), accordingly, may be implemented using one or more network servers (not shown), where each network server may represent a physical or a virtual network server. Additionally, or alternatively, any enterprise device (102A-102N) may be implemented using one or more computing systems similar to the exemplary computing system illustrated and described with respect to FIG. 4, below.

In one or many embodiment(s) described herein, the LLM (104) may represent any enterprise information technology (IT) infrastructure at least configured for multimodal information generation. More specifically, the LLM (104) may implement generative artificial intelligence, or the generation of text, images, and/or other data modalities using generative statistical and machine learning models. Said multimodal information, further, may be generated in response to prompts entailing natural language text describing tasks sought to be performed by the LLM (104). By way of a non-limiting example, a prompt may pose a query as to the difference(s) (if any) between a pair of inputs (e.g., two workload logs). In said non-limiting example, an appropriate LLM output may include text either: listing one or more differences found between the pair of inputs, or stating that zero differences had been identified. One of ordinary skill, however, will appreciate that the LLM (104) may perform other functionalities without departing from the scope of the embodiments described herein.

In one or many embodiment(s) described herein, the LLM (104) may be implemented through on-premises infrastructure, cloud computing infrastructure, or any hybrid infrastructure thereof. The LLM (104), accordingly, may be implemented using one or more network servers (not shown), where each network server may represent a physical or a virtual network server. Additionally, or alternatively, the LLM (104) may be implemented using one or more computing systems similar to the exemplary computing system illustrated and described with respect to FIG. 4, below.

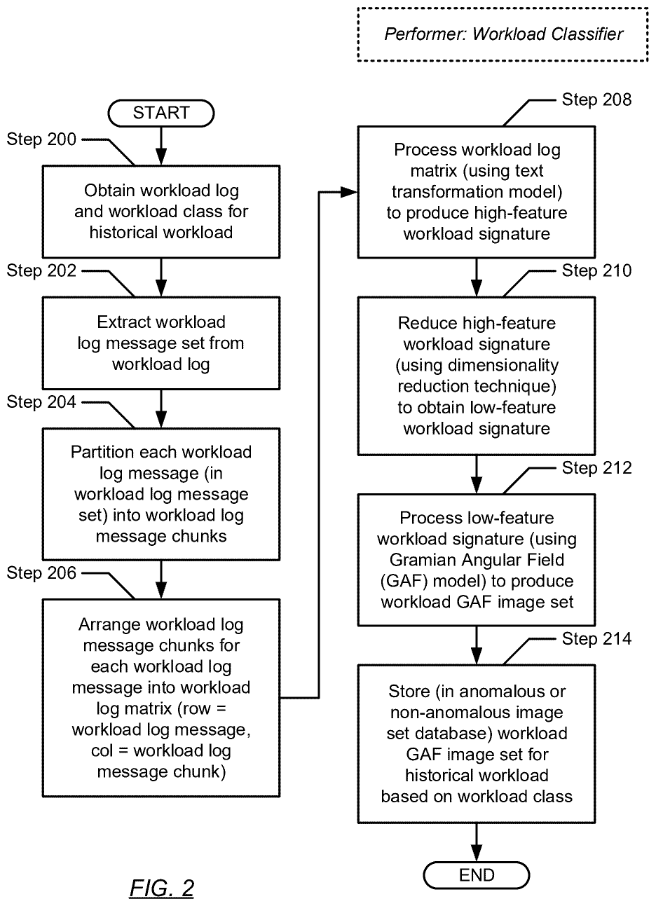

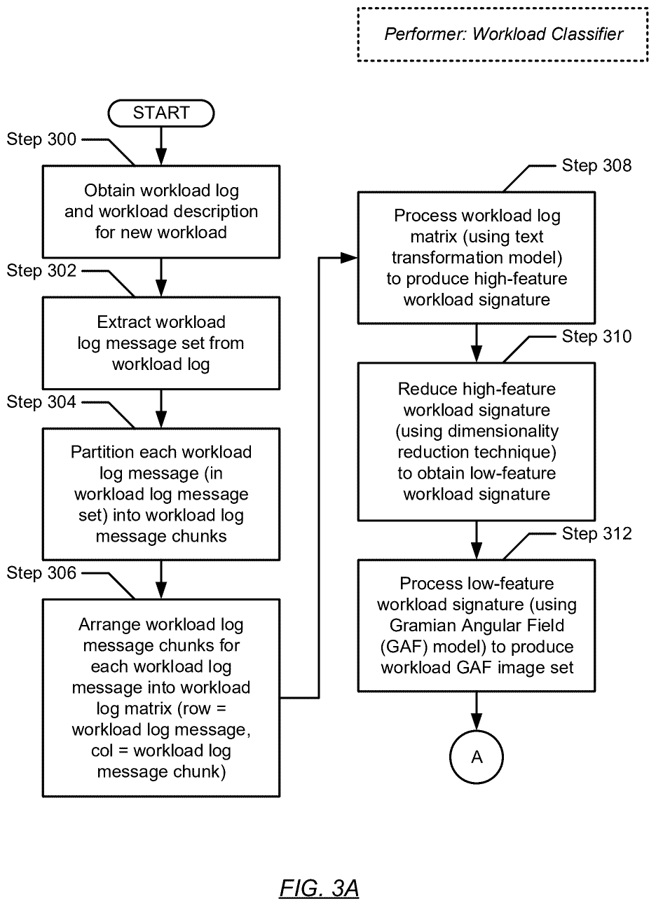

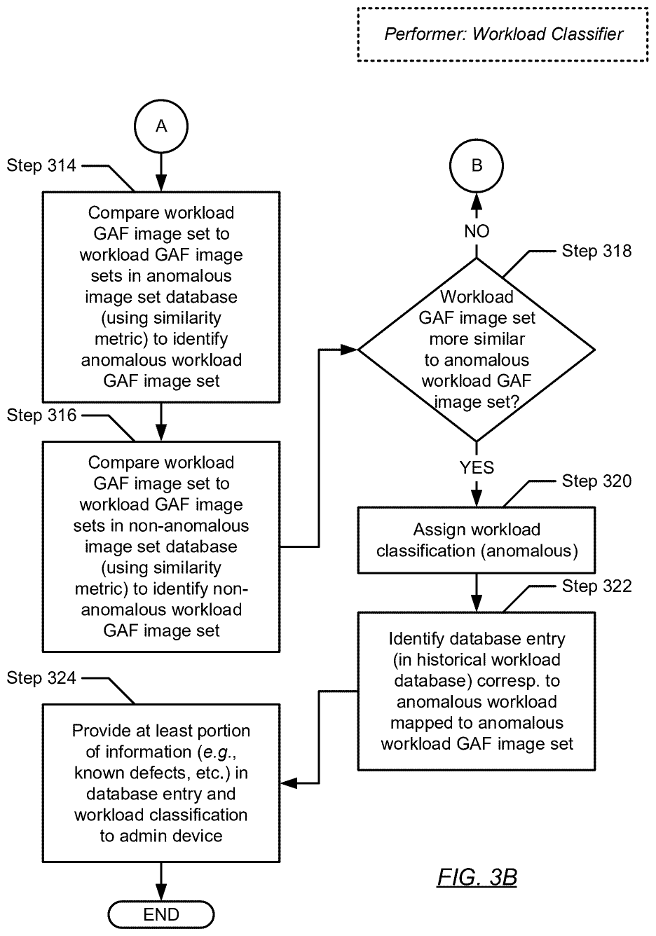

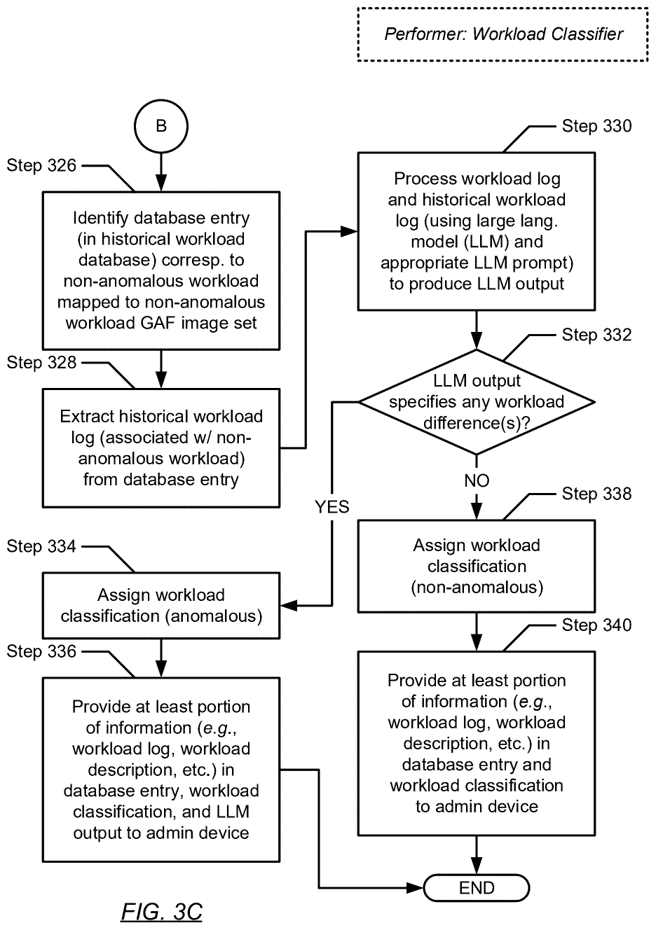

In one or many embodiment(s) described herein, the workload classifier (106) may represent any enterprise IT infrastructure at least configured for workload classification and/or workload log anomaly detection. More specifically, the workload classifier (106) may include functionality to: produce GAF image sets representative of historical workloads as illustrated and described with respect to FIG. 2, below; and classify new workloads based on GAF image set comparisons and provide descriptions outlining any anomalous new workloads using the LLM (104) as illustrated and described with respect to FIGS. 3A-3C, below. One of ordinary skill, however, will appreciate that the workload classifier (106) may perform other functionalities without departing from the scope of the embodiments described herein.

In one or many embodiment(s) described herein, the workload classifier (106) may be implemented through on-premises infrastructure, cloud computing infrastructure, or any hybrid infrastructure thereof. The workload classifier (106), accordingly, may be implemented using one or more network servers (not shown), where each network server may represent a physical or a virtual network server. Additionally, or alternatively, the workload classifier (106) may be implemented using one or more computing systems similar to the exemplary computing system illustrated and described with respect to FIG. 4, below. The workload classifier (106) is described in further detail below with respect to FIG. 1B.

In one or many embodiment(s) described herein, the admin device (108) may represent any physical appliance operated by one or many administrator(s) of one or more system (100) components. An administrator may refer to an individual or entity whom may be responsible for overseeing operations and maintenance regarding said system (100) component(s). To that end, and at least in part, the admin device (108) may enable any administrator(s) to control/configure, monitor, troubleshoot, and/or otherwise interact as needed with said system (100) component(s). Examples of the admin device (108) may include, but are not limited to, a desktop computer, a laptop computer, a network server, a smartphone, a tablet computer, or any other computing system similar to the exemplary computing system illustrated and described with respect to FIG. 4, below.

In one or many embodiment(s) described herein, the historical workload database (110) may represent a data storage system at least configured to store historical workload information describing one or more historical workloads. Said historical workload information may be maintained in/across any number of historical workload database entries (not shown). Any historical workload may refer to a workload (described above) instantiated on any enterprise device (102A-102N) in the past and, thus, no longer actively executing on said enterprise device (102A-102N). In contrast, any new workload (as described herein) may alternatively refer to a workload actively executing on any enterprise device (102A-102N).

Further, for any given historical workload, said historical workload information may include, but is not limited to: a (historical) workload log encompassing any number of events (and details thereof) at least concerning the given historical workload; a (historical) workload description entailing text summarizing a purpose for the given historical workload; a (historical) workload class or classification expressed as a label reflecting whether the given historical workload is classified as anomalous or non-anomalous; a known defect set (optional) entailing text summarizing one or more known defects (if any) that may be associated with the given historical workload; and a known solution set (optional) entailing text summarizing one or more known solutions (if any) that may address the known defect set. Said historical workload information, moreover and for any given historical workload, is not limited to the aforementioned specific examples.

In one or many embodiment(s) described herein, the historical workload database (110) may be implemented through on-premises infrastructure, cloud computing infrastructure, or any hybrid infrastructure thereof. The historical workload database (110), accordingly, may be implemented using one or more storage servers (not shown), where each storage server may represent a physical or a virtual storage server. Additionally, or alternatively, the historical workload database (110) may be implemented using one or more computing systems similar to the exemplary computing system illustrated and described with respect to FIG. 4, below.

In one or many embodiment(s) described herein, the storage server(s) of the historical workload database (110) may include a collection of one or more physical storage devices (not shown) on which various forms of digital information—e.g., historical workload information (described above)—may be maintained. Each physical storage device may encompass non-transitory computer readable storage media on which said digital information may be stored in whole or in part, and temporarily or permanently. Further, the physical storage device(s) may, at least in part, be implement using persistent (i.e., non-volatile) storage. Examples of persistent storage may include, but may not be limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

In one or many embodiment(s) described herein, the above-mentioned system (100) components (or subcomponents thereof) may communicate with one another through a network (not shown) (e.g., a local area network (LAN), a wide area network (WAN) such as the Internet, a mobile network, any other network type, or any combination thereof). The network may be implemented using any combination of wired and/or wireless connections. Further, the network may encompass various interconnected, network-enabled subcomponents (or systems) (e.g., switches, routers, gateways, etc.) that may facilitate communications between the above-mentioned system (100) components (or subcomponents thereof). Moreover, in communicating with one another, the above-mentioned system (100) components (or subcomponents thereof) may employ any combination of wired and/or wireless communication protocols.

While FIG. 1A shows a configuration of components and/or subcomponents, other system (100) configurations may be used without departing from the scope of the embodiments described herein.

FIG. 1B shows a workload classifier in accordance with one or more embodiments described herein. The workload classifier (106) may include any number of enterprise device interfaces (120), an admin device interface (122), a LLM interface (124), a workload database interface (126), a workload classifier controller (128), a GAF model (130), a text transformation model (132), an anomalous image set database (134), and a non-anomalous image set database (136). Each of these workload classifier (106) subcomponents is described below.

In one or many embodiment(s) described herein, any enterprise device interface (120) may refer to an enabler or a facilitator of communications (or information exchange) between the workload classifier (106) (or more specifically, the workload classifier controller (128)) and any enterprise device (see e.g., FIG. 1A). Examples of any enterprise device interface (120) may include networking hardware (e.g., a network card or adapter), a computer program implementing a logical interface (e.g., an application programming interface (API)) and executing on the underlying hardware of the workload classifier (106), an interactivity protocol, or any combination thereof. Further, any enterprise device interface (120) is not limited to the aforementioned specific examples.

In one or many embodiment(s) described herein, and at least in part, any enterprise device interface (120) may include functionality to: receive workload logs (described above) and workload descriptions for any new/active workload(s) instantiated on any enterprise device (see e.g., FIG. 1A); and provide said received workload logs and workload descriptions to the workload classifier controller (128) for processing in accordance with the method outlined in FIGS. 3A-3C, below. One of ordinary skill, however, will appreciate that any enterprise device interface (120) may perform other functionalities without departing from the scope of the embodiments described herein.

In one or many embodiment(s) described herein, the admin device interface (122) may refer to an enabler or a facilitator of communications (or information exchange) between the workload classifier (106) (or more specifically, the workload classifier controller (128)) and the admin device (see e.g., FIG. 1A). Examples of the admin device interface (122) may include networking hardware (e.g., a network card or adapter), a computer program implementing a logical interface (e.g., an API) and executing on the underlying hardware of the workload classifier (106), an interactivity protocol, or any combination thereof. Further, the admin device interface (122) is not limited to the aforementioned specific examples.

In one or many embodiment(s) described herein, and at least in part, the admin device interface (122) may include functionality to: obtain, from the workload classifier controller (128), workload classification details (described below) produced, or otherwise obtained, during/from the processing of any new/active workload(s); and transmit said workload classification details to the admin device for presentation/review by any administrator(s) operating said admin device. One of ordinary skill, however, will appreciate that the admin device interface (122) may perform other functionalities without departing from the scope of the embodiments described herein.

In one or many embodiment(s) described herein, workload classification details (as mentioned briefly above) may refer to information gathered during/from the processing of any new/active workload(s). Examples of said workload classification details, respective to a given new/active workload, may include one or more of: a workload class/classification (e.g., anomalous or non-anomalous) assigned to the given new/active workload; a known defect set and/or a known solution set (transplanted from historical workload information for a historical workload having a workload GAF image set most similar to another workload GAF image set pertaining to the given new/active workload); a workload log and a workload description associated with the given new/active workload; and a LLM output from the LLM, provided the workload log, a historical workload log, and an appropriate LLM prompt as inputs. Further, said workload classification details, for any given new/active workload, are not limited to the aforementioned specific examples.

In one or many embodiment(s) described herein, the LLM interface (124) may refer to an enabler or a facilitator of communications (or information exchange) between the workload classifier (106) (or more specifically, the workload classifier controller (128)) and the LLM (see e.g., FIG. 1A). Examples of the LLM interface (124) may include networking hardware (e.g., a network card or adapter), a computer program implementing a logical interface (e.g., an API) and executing on the underlying hardware of the workload classifier (106), an interactivity protocol, or any combination thereof. Further, the LLM interface (124) is not limited to the aforementioned specific examples.

In one or many embodiment(s) described herein, and at least in part, the LLM interface (124) may include functionality to: obtain, from the workload classifier controller (128) and for at least a part of the processing of a given new/active workload, a workload log for the given new/active workload, a historical workload log for a historical workload, and an appropriate LLM prompt (see e.g., example LLM prompt mentioned in FIG. 1A above); transmit the obtained workload log, the historical workload log, and the appropriate LLM prompt to the LLM for processing; receive, from the LLM, a LLM output based on said transmitted appropriate LLM prompt; and provide said received LLM output to the workload classifier controller (128) for at least another part of the processing of the given new/active workload. One of ordinary skill, however, will appreciate that the LLM interface (124) may perform other functionalities without departing from the scope of the embodiments described herein.

In one or many embodiment(s) described herein, the workload database interface (126) may refer to an enabler or a facilitator of communications (or information exchange) between the workload classifier (106) (or more specifically, the workload classifier controller (128)) and the historical workload database (see e.g., FIG. 1A). Examples of the workload database interface (126) may include networking hardware (e.g., a network card or adapter), a computer program implementing a logical interface (e.g., an API) and executing on the underlying hardware of the workload classifier (106), an interactivity protocol, or any combination thereof. Further, the workload database interface (126) is not limited to the aforementioned specific examples.

In one or many embodiment(s) described herein, and at least in part, the workload database interface (126) may include functionality to: receive, from the historical workload database and in response to push (e.g., event-driven) and/or pull (e.g., request-driven) mechanisms, workload logs and workload classes (or classifications) for any number of historical/inactive workloads; and provide the received workload logs and workload classes/classifications to the workload classifier controller (128) for the processing of said historical/inactive workload(s). One of ordinary skill, however, will appreciate that the workload database interface (126) may perform other functionalities without departing from the scope of the embodiments described herein.

In one or many embodiment(s) described herein, the workload classifier controller (128) may refer to instruction-processing hardware (e.g., any number of integrated circuits for processing computer readable instructions), a computer program executing on the underlying hardware of the workload classifier (106), or any combination thereof, at least configured to oversee and/or manage workload classifier (106) operations.

In one or many embodiment(s) described herein, and at least in part, the workload classifier controller (128) may include functionality to interact with the enterprise device interface(s) (120), the admin device interface (122), the LLM interface (124), the workload database interface (126), the anomalous image set database (134), and the non-anomalous image set database (136), as well as invoke the GAF model (130) and the text transformation model (132), in order to: produce GAF image sets representative of historical/inactive workloads as illustrated and described with respect to FIG. 2, below; and classify new workloads based on GAF image set comparisons and provide descriptions outlining any anomalous new workloads using the LLM (see e.g., FIG. 1A) as illustrated and described with respect to FIGS. 3A-3C, below. One of ordinary skill, however, will appreciate that the workload classifier controller (128) may perform other functionalities without departing from the scope of the embodiments described herein.

In one or many embodiment(s) described herein, the GAF model (130) may refer to instruction-processing hardware (e.g., any number of integrated circuits for processing computer readable instructions), a computer program executing on the underlying hardware of the workload classifier (106), or any combination thereof, at least configured to apply or perform GAF imaging. GAF imaging, in turn, may refer to an existing (well-known) computer vision technique or algorithm through which time-series data is encoded into images. More specifically, the time-series data is transformed using polar coordinates, and then, the cosine sum of the angles is computed for each pair of points, thereby producing matrices representative of GAF images.

In one or many embodiment(s) described herein, and at least in part, the GAF model (130) may include functionality to: be invoked by the workload classifier controller (128), where any said invocation(s) is/are provided with a low-feature workload signature (e.g., a low-dimensional numerical vector representation of any number of workload log message(s) in a workload log), for any workload(s), as input to undergo processing via GAF imaging; and produce, in response to any said invocation(s) and based on said processing, a workload GAF image set (e.g., a pair of GAF images) corresponding to said workload(s). One of ordinary skill, however, will appreciate that the GAF model (130) may perform other functionalities without departing from the scope of the embodiments described herein.

In one or many embodiment(s) described herein, the text transformation model (132) may refer to instruction-processing hardware (e.g., any number of integrated circuits for processing computer readable instructions), a computer program executing on the underlying hardware of the workload classifier (106), or any combination thereof, at least configured to apply or perform text vectorization. Text vectorization, in turn, may refer to an existing (well-known) natural language processing (NLP) technique or algorithm through which any granularity of text (e.g., one or more words) is transformed into a numerical vector capturing the semantic meaning and context of said text granularity. More specifically, the text granularity is projected into a high-dimensional latent (or embedding) space as a sequence of real-valued numbers, where said latent/embedding space is defined as a manifold in which (semantically) similar items (e.g., text granularities) are positioned closer to one another than less (semantically) similar items.

In one or many embodiment(s) described herein, and at least in part, the text transformation model (132) may include functionality to: be invoked by the workload classifier controller (128), where said invocation(s) is/are provided with a workload log matrix (e.g., a data structure reflecting any number of workload log message chunk(s) across any number of workload log message(s) in a workload log), for any workload(s), as input to undergo processing via text vectorization; and produce, in response to any said invocation(s) and based on said processing, a high-feature workload signature (e.g., a high-dimensional numerical vector representation of said workload log message(s) in the workload log) corresponding to said workload(s). One of ordinary skill, however, will appreciate that the text transformation model (132) may perform other functionalities without departing from the scope of the embodiments described herein.

In one or many embodiment(s) described herein, the anomalous image set database (134) may refer to a dedicated data repository at least configured to maintain any number of anomalous image set database entries (not shown). Each anomalous image set database entry, in turn, may store a workload GAF image set (described above) produced for, and thus associated with, an anomalous workload. Any anomalous workload may refer to any historical/inactive workload that exhibited, or any new/active workload that exhibits, abnormal behavior based on the processing of a workload log for said workload in accordance with embodiments described herein. Further, any workload having been assigned an anomalous label, representative of the workload class/classification associated therewith, is considered an anomalous workload.

In one or many embodiment(s) described herein, the non-anomalous image set database (136) may refer to a dedicated data repository at least configured to maintain any number of non-anomalous image set database entries (not shown). Each non-anomalous image set database entry, in turn, may store a workload GAF image set (described above) produced for, and thus associated with, a non-anomalous workload. Any non-anomalous workload may refer to any historical/inactive workload that exhibited, or any new/active workload that exhibits, normal behavior based on the processing of a workload log for said workload in accordance with embodiments described herein. Further, any workload having been assigned a non-anomalous label, representative of the workload class/classification associated therewith, is considered a non-anomalous workload.

While FIG. 1B shows a configuration of components and/or subcomponents, other workload classifier (106) configurations may be used without departing from the scope of the embodiments described herein.

FIG. 2 shows a flowchart describing a method for processing historical workload logs in accordance with one or more embodiments described herein. The various steps outlined below may be performed by the workload classifier (see e.g., FIGS. 1A and 1B). Further, while the various steps in the flowchart are presented and described sequentially, one of ordinary skill will appreciate that some or all steps may be executed in different orders, may be combined or omitted, and some or all steps may be executed in parallel.

Turning to FIG. 2, in Step 200, a workload log and a workload class are obtained for a historical (or inactive) workload. In one or many embodiment(s) described herein, the workload log may refer to a structured file including any number of event entries respectively pertaining to any number of events associated with the historical/inactive workload. An event, in turn, may refer to a notification entailing details (exemplified above-see e.g., FIG. 1A) corresponding to a significant action or occurrence at least concerning the historical/inactive workload. The workload class, meanwhile, may refer to a label reflecting whether the historical/inactive workload is classified as anomalous or non-anomalous.

In Step 202, a workload log message set is extracted from the workload log (obtained in Step 200). In one or many embodiment(s) described herein, the workload log message set may refer to, or include, a collection of one or more workload log messages. A workload log message, in turn, may refer to a portion or subset of the details pertaining to an event recorded in the workload log, where said details portion/subset specifically encompasses a text summary describing said event.

In Step 204, each workload log message, in the workload log message set (extracted in Step 202), is partitioned. That is, in one or many embodiment(s) described herein, the workload log message(s) may each be divided into workload log message chunks. A cardinality (or the number) of the workload log message chunks, for any workload log message, may be confined to a predefined maximum value (e.g., ten (10), fifteen (15), etc.). Similarly, the granularity of sequential text (e.g., one or more words), defining each workload log message chunk of any workload log message, may also be confined to a predefined maximum value (e.g., ten (10), fifteen (15), etc.). Further, should the partitioning of any workload log message result in a cardinality of workload log message chunks that is less than the predefined maximum cardinality value, then any empty workload log message chunk(s) (defining the gap between the actual cardinality and the predefined maximum cardinality) may be populated with an appropriate padding value/indicator.

In Step 206, the set(s) of workload log message chunks (obtained in Step 204) is/are arranged into a workload log matrix. In one or many embodiment(s) described herein, the workload log matrix may refer to a one- or two-dimensional data structure defined by a cardinality of (horizontal) rows and a cardinality of (vertical) columns. The cardinality of rows may equal the number of workload log messages in the workload log message set (extracted in Step 202), whereas the cardinality of columns may equal the predefined maximum cardinality value for the workload log message chunks. Any element (corresponding to a given row and a given column) of the workload log matrix may, therefore, store a sequence of words (or a padding value/indicator) belonging to the workload log message chunk tied to the given column, as well as represent a portion of the workload log message (from which the workload log message chunk was partitioned) tied to the given row.

In Step 208, the workload log matrix (obtained in Step 206) is processed using the text transformation model (see e.g., FIG. 1B). In one or many embodiment(s) described herein, the text transformation model may be invoked to apply text vectorization onto each element (i.e., [row, col.]) of the workload log matrix. That is, through text vectorization, any granularity of text (e.g., the sequence of words (or the padding value/indicator) stored in any element) may be transformed into a numerical vector capturing the semantic meaning and context of said text granularity. Furthermore, through said processing, a high-feature workload signature is produced, where said high-feature workload signature may refer to a high-dimensional numerical vector representation of the workload log message(s) (extracted in Step 202) that, at least in part, form the workload log (obtained in Step 200).

In Step 210, the high-feature workload signature (produced in Step 208) is reduced using a dimensionality reduction technique. In one or many embodiment(s) described herein, the dimensionality reduction technique may be invoked to apply dimensionality reduction onto the high-feature workload signature. Dimensionality reduction, more specifically, may refer to the projection of data from a high-dimensional space (where said data reflects a high number of features) into a lower-dimensional space (where said data reflects a lower number of features that still retain meaningful information). By way of a non-limiting example, dimensionality reduction may be applied through t-distributed stochastic neighbor embedding—an existing (well-known), unsupervised non-linear dimensionality reduction technique. Further, through said reducing, a low-feature workload signature is obtained, where said low-feature workload signature may refer to a low-dimensional numerical vector representation of the workload log message(s) (extracted in Step 202) that, at least in part, form the workload log (obtained in Step 200).

In Step 212, the low-feature workload signature (obtained in Step 210) is processed using the GAF model (see e.g., FIG. 1B). In one or many embodiment(s) described herein, the GAF model may be invoked to apply GAF imaging onto the low-feature workload signature. That is, through GAF imaging, time-series data (e.g., low-feature workload signature) may be encoded into images. Accordingly, through said processing, a workload GAF image set (e.g., a pair of GAF images), corresponding to the workload log (obtained in Step 200) and thus the historical/inactive workload, is produced.

In Step 214, the workload GAF image set (produced in Step 212) is stored in the appropriate image set database based on the workload class (obtained in Step 200). That is, in one or many embodiment(s) described herein, if the workload class for the historical/inactive workload reflects an anomalous label, then the workload GAF image set (alongside an identifier for the historical/inactive workload) may be stored in a database entry maintained in the anomalous image set database (see e.g., FIG. 1B). On the other hand, in one or many other embodiment(s) described herein, if the workload class for the historical/inactive workload reflects a non-anomalous label, then the workload GAF image set (alongside the identifier for the historical/inactive workload) may alternatively be stored in a database entry maintained in the non-anomalous image set database (see e.g., FIG. 1B).

FIGS. 3A-3C show a flowchart describing a method for processing new workload logs in accordance with one or more embodiments described herein. The various steps outlined below may be performed by the workload classifier (see e.g., FIGS. 1A and 1B). Further, while the various steps in the flowchart are presented and described sequentially, one of ordinary skill will appreciate that some or all steps may be executed in different orders, may be combined or omitted, and some or all steps may be executed in parallel.

Turning to FIG. 3A, in Step 300, a workload log and a workload description are obtained for a new (or active) workload. In one or many embodiment(s) described herein, the workload log may refer to a structured file including any number of event entries respectively pertaining to any number of events associated with the new/active workload. An event, in turn, may refer to a notification entailing details (exemplified above-see e.g., FIG. 1A) corresponding to a significant action or occurrence at least concerning the new/active workload. The workload description, meanwhile, may refer to text summarizing a purpose for/of the new/active workload.

In Step 302, a workload log message set is extracted from the workload log (obtained in Step 300). In one or many embodiment(s) described herein, the workload log message set may refer to, or include, a collection of one or more workload log messages. A workload log message, in turn, may refer to a portion or subset of the details pertaining to an event recorded in the workload log, where said details portion/subset specifically encompasses a text summary describing said event.

In Step 304, each workload log message, in the workload log message set (extracted in Step 302), is partitioned. That is, in one or many embodiment(s) described herein, the workload log message(s) may each be divided into workload log message chunks. A cardinality (or the number) of the workload log message chunks, for any workload log message, may be confined to a predefined maximum value (e.g., ten (10), fifteen (15), etc.). Similarly, the granularity of sequential text (e.g., one or more words), defining each workload log message chunk of any workload log message, may also be confined to a predefined maximum value (e.g., ten (10), fifteen (15), etc.). Further, should the partitioning of any workload log message result in a cardinality of workload log message chunks that is less than the predefined maximum cardinality value, then any empty workload log message chunk(s) (defining the gap between the actual cardinality and the predefined maximum cardinality) may be populated with an appropriate padding value/indicator.

In Step 306, the set(s) of workload log message chunks (obtained in Step 304) is/are arranged into a workload log matrix. In one or many embodiment(s) described herein, the workload log matrix may refer to a one- or two-dimensional data structure defined by a cardinality of (horizontal) rows and a cardinality of (vertical) columns. The cardinality of rows may equal the number of workload log messages in the workload log message set (extracted in Step 302), whereas the cardinality of columns may equal the predefined maximum cardinality value for the workload log message chunks. Any element (corresponding to a given row and a given column) of the workload log matrix may, therefore, store a sequence of words (or a padding value/indicator) belonging to the workload log message chunk tied to the given column, as well as represent a portion of the workload log message (from which the workload log message chunk was partitioned) tied to the given row.

In Step 308, the workload log matrix (obtained in Step 306) is processed using the text transformation model (see e.g., FIG. 1B). In one or many embodiment(s) described herein, the text transformation model may be invoked to apply text vectorization onto each element (i.e., [row, col.]) of the workload log matrix. That is, through text vectorization, any granularity of text (e.g., the sequence of words (or the padding value/indicator) stored in any element) may be transformed into a numerical vector capturing the semantic meaning and context of said text granularity. Furthermore, through said processing, a high-feature workload signature is produced, where said high-feature workload signature may refer to a high-dimensional numerical vector representation of the workload log message(s) (extracted in Step 302) that, at least in part, form the workload log (obtained in Step 300).

In Step 310, the high-feature workload signature (produced in Step 308) is reduced using a dimensionality reduction technique. In one or many embodiment(s) described herein, the dimensionality reduction technique may be invoked to apply dimensionality reduction onto the high-feature workload signature. Dimensionality reduction, more specifically, may refer to the projection of data from a high-dimensional space (where said data reflects a high number of features) into a lower-dimensional space (where said data reflects a lower number of features that still retain meaningful information). By way of a non-limiting example, dimensionality reduction may be applied through t-distributed stochastic neighbor embedding—an existing (well-known), unsupervised non-linear dimensionality reduction technique. Further, through said reducing, a low-feature workload signature is obtained, where said low-feature workload signature may refer to a low-dimensional numerical vector representation of the workload log message(s) (extracted in Step 302) that, at least in part, form the workload log (obtained in Step 300).

In Step 312, the low-feature workload signature (obtained in Step 310) is processed using the GAF model (see e.g., FIG. 1B). In one or many embodiment(s) described herein, the GAF model may be invoked to apply GAF imaging onto the low-feature workload signature. That is, through GAF imaging, time-series data (e.g., low-feature workload signature) may be encoded into images. Accordingly, through said processing, a workload GAF image set (e.g., a pair of GAF images), corresponding to the workload log (obtained in Step 300) and thus the new/active workload, is produced.

Turning to FIG. 3B, in Step 314, an anomalous workload GAF image set is identified. In one or many embodiment(s) described herein, identification of the anomalous workload GAF image set may result from: (a) a comparison between the workload GAF image set (produced in Step 312) and each existing workload GAF image set maintained in the anomalous image set database (see e.g., FIG. 1B), where said comparison(s) may measure a similarity between the workload GAF image set and the existing workload GAF image set via any existing (well-known) similarity metric (e.g., cosine similarity, etc.); and (b) a selection of the anomalous workload GAF image set as an existing workload GAF image set having a similarity metric score (e.g., for cosine similarity: a value nearest to +1.0) reflective of a highest similarity to the workload GAF image set over any other existing workload GAF image set maintained in the anomalous image set database.

In Step 316, a non-anomalous workload GAF image set is identified. In one or many embodiment(s) described herein, identification of the non-anomalous workload GAF image set may result from: (a) a comparison between the workload GAF image set (produced in Step 312) and each existing workload GAF image set maintained in the non-anomalous image set database (see e.g., FIG. 1B), where said comparison(s) may measure a similarity between the workload GAF image set and the existing workload GAF image set via any existing (well-known) similarity metric (e.g., cosine similarity, etc.); and (b) a selection of the non-anomalous workload GAF image set as an existing workload GAF image set having a similarity metric score (e.g., for cosine similarity: a value nearest to +1.0) reflective of a highest similarity to the workload GAF image set over any other existing workload GAF image set maintained in the non-anomalous image set database.

In Step 318, a determination is made as to whether the workload GAF image set (produced in Step 312) is more similar to the anomalous workload GAF image set (identified in Step 314) versus the non-anomalous workload GAF image set (identified in Step 316). Said determination may entail: (a) a comparison between a first similarity metric score associated with the anomalous workload GAF image set and a second similarity metric score associated with the non-anomalous workload GAF image set; and (b-i) a selection of the anomalous workload GAF image set as more similar to the workload GAF image set based on the first similarity metric score reflecting a greater similarity than the second similarity metric score, or (b-ii) a selection of the non-anomalous workload GAF image set as more similar to the workload GAF image set based on the second similarity metric score reflecting a greater similarity than the first similarity metric score.

As such, in one or many embodiment(s) described herein, if it is determined that the workload GAF image set (produced in Step 312) is more similar to the anomalous workload GAF image set (identified in Step 314), then the method proceeds to Step 320. On the other hand, in one or many other embodiment(s) described herein, if it is alternatively determined that the workload GAF image set is more similar to the non-anomalous workload GAF image set (identified in Step 316), then the method alternatively proceeds to Step 326 (see e.g., FIG. 3C).

In Step 320, following the determination (made in Step 318) that the workload GAF image set (produced in Step 312) is more similar to the anomalous workload GAF image set (identified in Step 314), the new/active workload is assigned a workload class/classification reflecting an anomalous label. That is, in one or many embodiment(s) described herein, because the workload GAF image set is most similar to the anomalous GAF image set, the new/active workload associated with the former is assigned the same workload class/classification of a historical/inactive workload associated with the latter.

In Step 322, a database entry, in the historical workload database (see e.g., FIG. 1A), is identified. In one or many embodiment(s) described herein, identification of the database entry may encompass: (a) an identification of a (anomalous) historical/inactive workload mapped to the anomalous workload GAF image set (identified in Step 314); and (b) a selection of the database entry, which corresponds to said (anomalous) historical/inactive workload.

In Step 324, objects are provided to the admin device (see e.g., FIG. 1A). In one or many embodiment(s) described herein, said provided objects may include: an identifier for the new/active workload; at least a portion of the historical workload information (e.g., known defect set, known solution set (if any), etc.) stored in the database entry (identified in Step 322); the workload log and workload description (obtained in Step 300); and the workload class/classification (assigned in Step 320). Said provided objects, further, are not limited to the aforementioned specific examples.

In one or many embodiment(s) described herein, once the objects (provided in Step 324) are received by the admin device, any administrator(s) operating said admin device may update the historical workload database (see e.g., FIG. 1A) to include a database entry for the new/active workload that stores at least a subset of said objects.

Turning to FIG. 3C, in Step 326, following the alternate determination (made in Step 318) that the workload GAF image set (produced in Step 312) is more similar to the non-anomalous workload GAF image set (identified in Step 316), a database entry, in the historical workload database (see e.g., FIG. 1A), is identified. In one or many embodiment(s) described herein, identification of the database entry may encompass: (a) an identification of a (non-anomalous) historical/inactive workload mapped to the non-anomalous workload GAF image set; and (b) a selection of the database entry, which corresponds to said (non-anomalous) historical/inactive workload.

In Step 328, a historical workload log is extracted from the database entry (identified in Step 326). In one or many embodiment(s) described herein, the historical workload log may correspond to a non-anomalous historical/inactive workload mapped to the database entry. Further, the historical workload log may refer to a structured file including any number of event entries respectively pertaining to any number of events associated with the non-anomalous historical/inactive workload.

In Step 330, the workload log (obtained in Step 300), for the new/active workload, and the historical workload log (extracted in Step 328), for the non-anomalous historical/inactive workload, are processed using the LLM (see e.g., FIG. 1A) and based on an appropriate LLM prompt. In one or many embodiment(s) described herein, the LLM may implement generative artificial intelligence, or the generation of text, images, and/or other data modalities using generative statistical and machine learning models. The LLM prompt, moreover, may entail natural language text describing tasks sought to be performed by the LLM given the workload log and the historical workload log as inputs. Furthermore, the LLM prompt may pose a query as to the difference(s) (if any) between the workload log and the historical workload log. Through said processing by the LLM, an LLM output is produced, which may include text either: listing one or more differences found between the workload log and the historical workload log, or stating that zero differences had been identified.

### Example LLM Prompt & LLM Output Listing Differences

LLM Prompt: How are the new workload and the historical workload different based on the provided workload and historical workload logs?

LLM Output: Here are some key differences between the new workload and the historical workload. The workload log of the new workload log: (1) lists only two further categories of non-relational DBMS-object-oriented database management systems and multi-value database management systems; (2) does not include end-user database management systems or navigational database management systems in the further categories; and (3) emphasizes a more concise set of non-relational DBMS types.

### Example LLM Prompt & LLM Output Stating No Differences

LLM Prompt: How are the new workload and the historical workload different based on the provided workload and historical workload logs?

LLM Output: There is no gap between the new workload and the historical workload.

In Step 332, a determination is made as to whether the LLM output (produced in Step 330) specifies any workload difference(s) between the workload log (obtained in Step 300) and the historical workload log (extracted in Step 328). In one or many embodiment(s) described herein, if it is determined that the LLM output includes text listing at least one workload difference, then the method proceeds to Step 334. On the other hand, in one or many other embodiment(s) described herein, if it is alternatively determined that the LLM output includes text stating that zero differences had been identified, then the method alternatively proceeds to Step 338.

In Step 334, following the determination (made in Step 332) that the LLM output (produced in Step 330) specifies at least one workload difference between the workload log (obtained in Step 330) and the historical workload log (extracted in Step 328), the new/active workload is assigned a workload class/classification reflecting an anomalous label. That is, in one or many embodiment(s) described herein, because the workload log reflects differences with respect to the historical workload log, the new/active workload associated with the former is assigned a different workload class/classification of the (non-anomalous) historical/inactive workload associated with the latter.

In Step 336, objects are provided to the admin device (see e.g., FIG. 1A). In one or many embodiment(s) described herein, said provided objects may include: an identifier for the new/active workload; at least a portion of the historical workload information (e.g., historical workload log, historical workload description, etc.) stored in the database entry (identified in Step 326); the workload log and workload description (obtained in Step 300); the workload class/classification (assigned in Step 334); and the LLM prompt and the LLM output (provided and produced, respectively, in Step 330). Said provided objects, further, are not limited to the aforementioned specific examples.

In one or many embodiment(s) described herein, once the objects (provided in Step 336) are received by the admin device, any administrator(s) operating said admin device may update the historical workload database (see e.g., FIG. 1A) to include a database entry for the new/active workload that stores at least a subset of said objects.

In Step 338, following the alternate determination (made in Step 332) that the LLM output (produced in Step 330) specifies zero differences between the workload log (obtained in Step 330) and the historical workload log (extracted in Step 328), the new/active workload is assigned a workload class/classification reflecting a non-anomalous label. That is, in one or many embodiment(s) described herein, because the workload log reflects no differences with respect to the historical workload log, the new/active workload associated with the former is assigned a same workload class/classification of the (non-anomalous) historical/inactive workload associated with the latter.

In Step 340, objects are provided to the admin device (see e.g., FIG. 1A). In one or many embodiment(s) described herein, said provided objects may include: an identifier for the new/active workload; at least a portion of the historical workload information (e.g., historical workload log, historical workload description, etc.) stored in the database entry (identified in Step 326); the workload log and workload description (obtained in Step 300); and the workload class/classification (assigned in Step 338). Said provided objects, further, are not limited to the aforementioned specific examples.

In one or many embodiment(s) described herein, once the objects (provided in Step 340) are received by the admin device, any administrator(s) operating said admin device may update the historical workload database (see e.g., FIG. 1A) to include a database entry for the new/active workload that stores at least a subset of said objects.

FIG. 4 shows a computing system in accordance with one or more embodiments described herein. The computing system (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one or many embodiment(s) described herein, the computer processor(s) (402) may be an integrated circuit for processing instructions. For example, the computer processor(s) may be one or more cores or micro-cores of a central processing unit (CPU) and/or a graphics processing unit (GPU). The computing system (400) may also include one or more input devices (410), such as a touchscreen, keyboard, mouse, microphone, touchpad, electronic pen, or any other type of input device. Further, the communication interface (412) may include an integrated circuit for connecting the computing system (400) to a network (not shown) (e.g., a local area network (LAN), a wide area network (WAN) such as the Internet, mobile network, or any other type of network) and/or to another device, such as another computing device.

In one or many embodiment(s) described herein, the computing system (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing systems exist, and the aforementioned input and output device(s) may take other forms.

Software instructions in the form of computer readable program code to perform embodiments described herein may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments described herein.

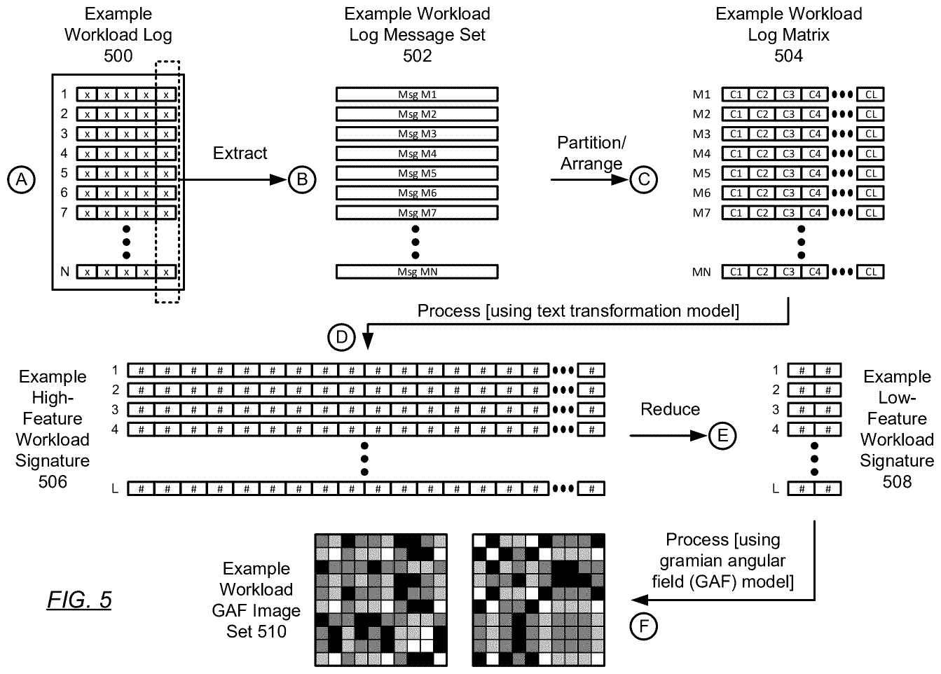

FIG. 5 shows an example generation of a workload gramian angular field (GAF) image set in accordance with one or more embodiments described herein. The following example generation of a workload GAF image set is for explanatory purposes only and not intended to limit the scope of the embodiments described herein.

Turning to FIG. 5:
A. An Example Workload Log (500), for either a new/active workload or a historical/inactive workload, is obtained and includes details pertaining to chronologically listed events 1-N;
B. An Example Workload Log Message Set (502) is extracted from the Example Workload Log (500) and includes a workload log message respective to each event, where the workload log message represents a portion of the details pertaining to the event;
C. An Example Workload Log Matrix (504) is obtained based on a partitioning of each workload log message in the Example Workload Log Message Set (502) into respective workload log message chunks, where the Example Workload Log Matrix (504) stores a sequence of words defining each workload log message chunk belonging to a given workload log message within an element cross-referenced by a column (of L columns) mapped to the sequential position of the workload log message chunk in the given workload log message and by a row (of N rows) mapped to the given workload log message;
D. An Example High-Feature Workload Signature (506) is produced through processing of the Example Workload Log Matrix (504) using a text transformation model and includes a high-dimensional numerical vector for each column (of L columns) defining the Example Workload Log Matrix (504), where the high-dimensional numerical vector for any column results from text vectorization applied to the merging or concatenation of the N sequences of words stored in the elements at least referenced by the column;
E. An Example Low-Feature Workload Signature (508) is obtained following dimensionality reduction applied to the Example High-Feature Workload Signature (506) and includes a lower-dimensional numerical vector for each column (of L columns) defining the Example Workload Log Matrix (504), where the lower-dimensional numerical vector still retains meaningful information that had been exhibited by the corresponding high-dimensional numerical vector of the Example High-Feature Workload Signature (506); and
F. An Example Workload GAF Image Set (510) is produced through processing of the Example Low-Feature Workload Signature (508) using GAF imaging.

While the embodiments described herein have been described with respect to a limited number of embodiments, those skilled in the art, having benefit of this disclosure, will appreciate that other embodiments can be devised which do not depart from the scope of the embodiments described herein. Accordingly, the scope of the embodiments described herein should be limited only by the attached claims.

What is claimed is:

1. A method for workload classification, the method comprising:
obtaining a workload log for a workload;
producing, for the workload and based on the workload log, a workload gramian angular field (GAF) image set; and
assigning, to the workload, a workload class at least based on the workload GAF image set.

2. The method of claim 1, the method further comprising:
prior to assigning the workload class to the workload:
identifying, associated with a second workload classified as anomalous, a second workload GAF image set similar to the workload GAF image set;
identifying, associated with a third workload classified as non-anomalous, a third workload GAF image set similar to the workload GAF image set;
making a determination that the workload GAF image set is more similar to the third workload GAF image set than the second workload GAF image set;
obtaining, based on the determination, a second workload log for the third workload; and
processing, using a large language model (LLM), the workload log and the second workload log to produce a LLM output,
wherein the workload class assigned to the workload is further based on the LLM output.

3. The method of claim 2, wherein the LLM output specifies at least one difference between the workload log and the second workload log.

4. The method of claim 3, the workload class assigned to the workload matches that of the second workload.

5. The method of claim 2, wherein the LLM output specifies zero differences between the workload log and the second workload log.

6. The method of claim 5, wherein the workload class assigned to the workload matches that of the third workload.

7. The method of claim 2, wherein the workload is active, and wherein the second and third workloads are inactive.

8. The method of claim 1, the method further comprising:
prior to assigning the workload class to the workload:
identifying, associated with a second workload classified as anomalous, a second workload GAF image set similar to the workload GAF image set;
identifying, associated with a third workload classified as non-anomalous, a third workload GAF image set similar to the workload GAF image set; and
making a determination that the workload GAF image set is more similar to the second workload GAF image set than the third workload GAF image set,
wherein the workload class assigned to the workload matches that of the second workload based on the determination.

9. The method of claim 1, wherein producing the workload GAF image set for the workload, comprises:
extracting, from the workload log, a plurality of workload log messages;
partitioning, of the plurality of workload log messages, each workload log message into workload log message chunks;
arranging the workload log message chunks for each workload log message into a workload log matrix;
producing, for the workload, a high-feature workload signature through processing of the workload log matrix using text vectorization; and
reducing the high-feature workload signature into a low-feature workload signature,
wherein the workload GAF image set is produced through processing of the low-feature workload signature using GAF imaging.

10. A non-transitory computer readable medium (CRM) comprising computer readable program code, which when executed by a computer processor, enables the computer processor to perform a method for workload classification, the method comprising:
obtaining a workload log for a workload;
producing, for the workload and based on the workload log, a workload gramian angular field (GAF) image set; and
assigning, to the workload, a workload class at least based on the workload GAF image set.

11. The non-transitory CRM of claim 10, the method further comprising:
prior to assigning the workload class to the workload:
identifying, associated with a second workload classified as anomalous, a second workload GAF image set similar to the workload GAF image set;
identifying, associated with a third workload classified as non-anomalous, a third workload GAF image set similar to the workload GAF image set;
making a determination that the workload GAF image set is more similar to the third workload GAF image set than the second workload GAF image set;
obtaining, based on the determination, a second workload log for the third workload; and
processing, using a large language model (LLM), the workload log and the second workload log to produce a LLM output,
wherein the workload class assigned to the workload is further based on the LLM output.

12. The non-transitory CRM of claim 11, wherein the LLM output specifies at least one difference between the workload log and the second workload log.

13. The non-transitory CRM of claim 12, the workload class assigned to the workload matches that of the second workload.

14. The non-transitory CRM of claim 11, wherein the LLM output specifies zero differences between the workload log and the second workload log.

15. The non-transitory CRM of claim 14, wherein the workload class assigned to the workload matches that of the third workload.

16. The non-transitory CRM of claim 11, wherein the workload is active, and wherein the second and third workloads are inactive.

17. The non-transitory CRM of claim 10, the method further comprising:
prior to assigning the workload class to the workload:
identifying, associated with a second workload classified as anomalous, a second workload GAF image set similar to the workload GAF image set;
identifying, associated with a third workload classified as non-anomalous, a third workload GAF image set similar to the workload GAF image set; and
making a determination that the workload GAF image set is more similar to the second workload GAF image set than the third workload GAF image set,
wherein the workload class assigned to the workload matches that of the second workload based on the determination.

18. The non-transitory CRM of claim 10, wherein producing the workload GAF image set for the workload, comprises:
extracting, from the workload log, a plurality of workload log messages;
partitioning, of the plurality of workload log messages, each workload log message into workload log message chunks;
arranging the workload log message chunks for each workload log message into a workload log matrix;
producing, for the workload, a high-feature workload signature through processing of the workload log matrix using text vectorization; and
reducing the high-feature workload signature into a low-feature workload signature,
wherein the workload GAF image set is produced through processing of the low-feature workload signature using GAF imaging.

19. A system, comprising:
at least one enterprise device; and
a workload classifier operatively connected to the at least one enterprise device, and comprising a computer processor configured to perform a method for workload classification, the method comprising:
obtaining, from an enterprise device of the at least one enterprise device, a workload log for a workload instantiated thereon;
producing, for the workload and based on the workload log, a workload gramian angular field (GAF) image set; and
assigning, to the workload, a workload class at least based on the workload GAF image set.

20. The system of claim 19, further comprising:
a large language model (LLM) operatively connected to the workload classifier,
wherein the method further comprises:
prior to assigning the workload class to the workload:
identifying, associated with a second workload classified as anomalous, a second workload GAF image set similar to the workload GAF image set;
identifying, associated with a third workload classified as non-anomalous, a third workload GAF image set similar to the workload GAF image set;
making a determination that the workload GAF image set is more similar to the third workload GAF image set than the second workload GAF image set;
obtaining, based on the determination, a second workload log for the third workload; and
processing, using the LLM, the workload log and the second workload log to produce a LLM output,
wherein the workload class assigned to the workload is further based on the LLM output.
